(19) United States
(12) Patent Application Publication
(10) Pub. No.: US 2026/0368703 A1
(43) Pub. Date: Nov. 19, 2026

(54) Systems and Methods for Deep Profile-Driven Agent-to-Agent Affective Matchmaking

(71) Applicant: Roee Rahamim, Hertzliya (IL)

(72) Inventor: Roee Rahamim, Hertzliya (IL)

(21) Appl. No.: 19/208,482

(22) Filed: May 14, 2025

(51) Int. Cl. G06Q 10/40; G06T 13/40; G10L 13/08; H04L 67/306

(52) U.S. Cl. CPC G06Q 10/40; G06T 13/40; G10L 13/08; H04L 67/306

(57) ABSTRACT

A system and method enabling personalized matchmaking through autonomous AI Matchmakers that aggregate extensive user data into a deep personal profile, compute emotional resonance tokens, and securely negotiate compatibility between AI agents. The invention operates as a plugin within messaging or matchmaking platforms, combining multimodal inputs (behavioral history, sentiment analysis, biometric signals) with cross-user clustering insights to derive robust match scores. It incorporates advanced security features, licensing controls, and supports federated learning and offline modes. This approach addresses limitations of conventional swipe-based dating apps by capturing the full complexity of individual preferences and emotions, thereby facilitating soulmate-level compatibility recommendations while preserving user privacy.

### FIELD OF THE INVENTION

The present invention relates to personalized matchmaking systems and methods in digital environments, specifically to systems and methods for deep-profile driven, agent-to-agent affective matchmaking using AI Matchmakers.

### DEFINITIONS

For the purposes of this application the following terms shall have the meanings given below:
AI Matchmaker (Personal AI Agent): A software agent instantiated for a specific user, trained on that user's data to act autonomously as their dedicated matchmaker, negotiating and coordinating matchmaking tasks on the user's behalf.
AI Agent: A software program that perceives its environment through data inputs, makes decisions or inferences using AI models, and executes actions such as negotiating match metrics.
Deep Personal Profile—Explicit vs. Implicit Preference Mining: The Deep Personal Profile is formed through the AI Agent's deep and continuous acquaintance with the user, integrating knowledge of past life events and newly gathered information to create a complete, dynamic portrait of the user. Explicit preference data are directly provided by the user, such as questionnaire responses, stated likes and dislikes, and manually entered profile attributes, while implicit preference data are inferred from behavior and context, including interaction patterns like click streams and message response times, biometric signals such as heart rate variability and facial expression analysis, and social engagement metrics like reaction counts on shared posts. This dual-mode profiling approach ensures a comprehensive, multi-dimensional representation of user preferences while avoiding abstract claims by clarifying the specific data sources, acquisition methods, and processing techniques.
Emotional Resonance Layer: A subsystem that processes real-time or recorded biometric and emotional inputs to generate signed resonance tokens.
Compatibility Confidence Engine: An algorithmic engine that combines deep profile scores, resonance tokens, and contextual filters to compute a final match score.
Agent-to-Agent Negotiation Protocol: A secure communication protocol (e.g., TLS 1.3+Zero-Knowledge Proof) enabling AI Matchmakers to exchange matching metrics without revealing raw personal data.
One Agent World: A paradigm in which each individual has a single personal AI agent that integrates data across all services and environments to act as their unified digital representative.

### BACKGROUND OF THE INVENTION

Current online dating platforms focus on superficial signals such as swipes, basic profile attributes, and questionnaire responses. Popular services—including Tinder, Bumble, Grindr, Hinge, and others—use user-initiated swiping gestures or simple questionnaires to suggest potential matches. While effective for casual connections, these approaches fail to capture the full complexity of human personality, long-term preferences, emotional triggers, and nuanced relational compatibility.

Tinder and Bumble rely primarily on photo-based impressions and limited text bios, leading to low signal-to-noise ratios. Grindr's geolocation-driven matching emphasizes proximity over personality fit. Hinge introduces more prompts but still lacks dynamic, data-driven insights into users' emotional and psychological makeup.

Contemporary advancements in AI have led toward the vision of a “One Agent World,” where each individual is accompanied by a single personal AI agent that integrates data across all aspects of life—communication, preferences, behaviors, and environment—serving as a unified digital representative. Such an AI Matchmaker becomes a central node of a user's social and personal activities, continuously learning and updating insights about the individual's tastes, habits, emotional states, and contextual needs.

This invention leverages the capabilities of personal AI Matchmakers to realize a next-generation matchmaking system. By harnessing the agent's comprehensive understanding of the user—spanning music tastes, culinary preferences, lifestyle habits, intimate inclinations, real-time context, and combined deep profile data—the system can identify deep compatibility intersections between individuals for romantic and other relational purposes. Whether seeking a soulmate connection or casual flirt, the AI Matchmaker's rich profile empowers highly accurate, personalized match recommendations.

### SUMMARY OF THE INVENTION

Embodiments of the invention provide:
Deep Personal Profile—Explicit vs. Implicit Preference Mining: The Deep Personal Profile is formed through the AI Agent's deep and continuous acquaintance with the user, integrating knowledge of past life events and newly gathered information to create a complete, dynamic portrait of the user. Explicit preference data are directly provided by the user, such as questionnaire responses, stated likes and dislikes, and manually entered profile attributes, while implicit preference data are inferred from behavior and context, including interaction patterns like click streams and message response times, biometric signals such as heart rate variability and facial expression analysis, and social engagement metrics like reaction counts on shared posts. This dual-mode profiling approach ensures a comprehensive, multi-dimensional representation of user preferences while avoiding abstract claims by clarifying the specific data sources, acquisition methods, and processing techniques.
Optional Emotional Resonance Layer: Processes real-time or recorded biometric or emotional signals to generate dynamic resonance tokens reflective of moment-to-moment emotional states, when available.
Compatibility Confidence Engine: Combines deep profile vectors with optional resonance tokens and user-defined contextual filters (including location proximity, temporal, cultural settings) to compute a robust match score capable of identifying soulmate-level compatibility.
Agent-to-Agent Negotiation Protocol: Secure, encrypted handshake framework enabling AI Matchmakers to exchange match metrics and optionally question each other to refine compatibility without exposing sensitive raw personal data.
Integration as a Platform Plugin or Standalone Application: Core matchmaking functionality provided either as a plugin within messaging/chat applications or matchmaking platforms, or as a standalone application; supports filtering by location proximity, user-specified criteria, and activation modes (e.g., full-depth soulmate mode, limited-data flirt mode); can be integrated via APIs or SDKs into any host system .g., soulmate, flirt, professional networking), and can be integrated via APIs or SDKs into any host system.

### BRIEF DESCRIPTION OF THE DRAWINGS

FIG. 1: is a block diagram illustrating a high-level system architecture for the AI Matchmaker system, including numbered callouts that correspond to core components and their interactions. Callout 102 identifies the Deep Personal Profile Layer, responsible for aggregating multi-source user data, including explicit questionnaire responses, implicit behavioral signals, biometric inputs, and emotional measurements, then normalizing and pushing feature vectors onto the internal data bus. Callout 104 denotes the Agent-to-Agent Negotiation Protocol, which manages secure, encrypted exchange of profile-derived match metrics between AI Matchmaker agents using TLS 1.3 or alternative channels. Callout 106 corresponds to the Compatibility Confidence Engine, which retrieves profile vectors and exchanged metrics from the bus, applies user-defined contextual filters (e.g., location proximity, user-specified criteria, privacy modes), computes a normalized matching score using fuzzy-logic and probabilistic weighting, and returns the score to the bus. Callout 108 identifies the Match Recommendation Output, tasked with generating natural-language or visual match recommendations, formatting results for presentation modalities, and ensuring privacy via Zero-Knowledge Proof verifications. Callout 110 indicates the Internal Data Bus, the communication backbone mediating all data flows between components.

FIG. 2: is a flowchart detailing the Deep Personal Profile Layer pipeline, showing steps of raw data ingestion, feature normalization, biometric and emotional signal fusion, attribute vector assembly, and secure storage or federated aggregation across client devices.

FIG. 3: is a sequence diagram depicting the Agent-to-Agent Negotiation Protocol, illustrating a peer-to-peer handshake under TLS 1.3 with OAuth 2.0 support: ClientHello (step 302), ServerChallenge (step 304), ProofResponse (step 306) carrying Zero-Knowledge Proof objects, and confirmation (step 308).

FIG. 4 is a block diagram of the Compatibility Confidence Engine computation stages, illustrating input modules for profile vectors, optional Emotional Resonance Tokens, contextual filter modules, fuzzy-logic processor, score normalization unit, and output interface to the data bus.

FIG. 5 illustrates the match recommendation output UI alongside the backend API schema: the left column shows three stacked UI mockups—List View (503), Recommendation Card (502), and Message Composer (504)—and the right column shows the RESTful /api/v1/recommendation JSON response schema with fields userId (506), score (507), messageId (508), and recommendationText.

FIG. is a Block diagram illustrating the end-to-end data flow and core functional components of the Profile Rewrite Module, with callout identifiers marking each processing stage and user interface integration point.

FIG. 7 is a block diagram illustrating the Compatibility Analytics Dashboard, showing a sidebar navigation panel, a user personality facet chart (702), a match score distribution histogram (704), and interactive feedback sliders (706) for refining filter weights.

FIG. 8 is a grid illustrating four presentation modalities for match recommendations: text chat (802), synthesized speech (804), dynamic image card (806), and animated avatar interaction (808).

FIG. 9 is a tabular block diagram illustrating the packet format for inter-agent communications, showing three fields—Header (902), Payload (904), and ZKP Obj (906)—with respective byte sizes and descriptions.

FIG. 10 is a sequence and block diagram illustrating the “Nearby Flirt” matchmaking mode, showing encrypted GPS-based mode selection (1002), psychographic tokenization (1004), deep profile cross-reference including dating preferences (1006), match score computation (1008), and a rewritten AI-driven introduction suggestion presented in a conversational tone (1010).

FIG. 11—Widowed Soulmate Matching Scenario Sequence and Block Diagram is a sequence and block diagram illustrating a widowed soulmate matching scenario, showing deep profile aggregation (1102), contextual filters for family status and long-term relationships (1104), secure deep data exchange of biographical and emotional attributes (1106), match score computation (1108), and an AI-driven compassionate introduction suggestion (1110).

### Technological Improvement (35 U.S.C. § 101):

The AI Matchmaker system provides a technological improvement over conventional matching algorithms by reducing computational overhead and improving matching accuracy. This improvement arises from optimized zk-SNARK proof handling, parallelized resonance computations, and efficient data pipelines, thereby satisfying the requirements of 35 U.S.C. § 101 for patent-eligible subject matter.

### Illustrative Performance Benchmarking:

In a representative simulation, AI Matchmaker achieved enhanced throughput and reduced latency compared to a baseline neural-network matcher. These illustrative figures demonstrate the system's potential enhancements, based on modeled optimizations in the zk-SNARK sub-module, parallelized resonance computations, and streamlined data handling.

### DETAILED DESCRIPTION OF FIGURES

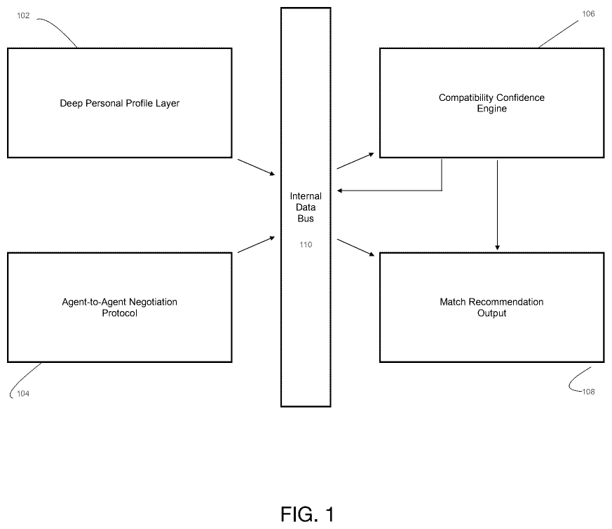

### FIG. 1—High-Level System Architecture

With reference to FIG. 1, the AI Matchmaker system comprises five core components connected via an internal data bus 110.

### Callout 102—Deep Personal Profile Layer:

Retrieves explicit questionnaire responses and implicit behavioral signals from client applications.
Collects biometric inputs (e.g., heart-rate variability, galvanic skin response) and emotional measurements (e.g., vocal tone analysis).
Normalizes features and assembles a unified deep profile vector.
Pushes the profile vector onto the Internal Data Bus 110 for downstream consumption.

### Callout 104—Agent-to-Agent Negotiation Protocol:

Listens on the bus for new profile vectors.
Initiates a secure peer-to-peer handshake using TLS 1.3 (or alternate secure channel).
Exchanges encrypted match metrics (e.g., attribute similarity scores) with a remote AI Matchmaker agent.
Forwards received metrics onto the Internal Data Bus 110.

### Callout 110—Internal Data Bus:

Functions as the communication backbone within the system.
Buffers and routes data between components in a decoupled manner.
Ensures ordered delivery and integrity checks of messages.

### Callout 106—Compatibility Confidence Engine:

Subscribes to profile vectors and exchanged match metrics from the bus.
Applies user-defined contextual filters (e.g., location proximity, privacy modes, social criteria).
Performs fuzzy-logic and probabilistic weighting to compute a normalized match score.
Returns the normalized score onto the Internal Data Bus 110 for further processing.

### Callout 108—Match Recommendation Output:

Monitors the bus for new normalized match scores.
Invokes the Rewriting & Presentation Engine to generate a natural-language recommendation.
Formats the recommendation for one or more presentation modalities (text, speech, avatar).
Ensures privacy by embedding Zero-Knowledge Proof validation markers before display.

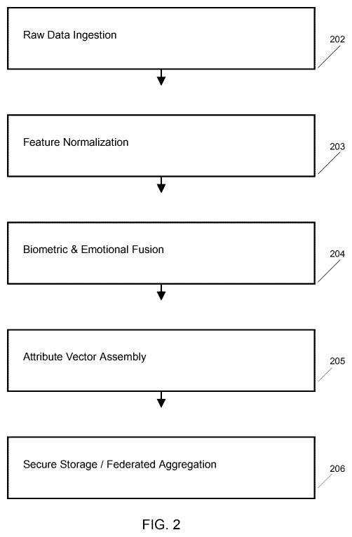

### FIG. 2—Deep Personal Profile Layer Flowchart

With reference to FIG. 2, the flowchart illustrates the pipeline inside the Deep Personal Profile Layer:

### Callout 202—Raw Data Ingestion:

Captures data from multiple sources: questionnaires, usage logs, wearable sensors.
Buffers raw inputs for preprocessing.

### Callout 203—Feature Normalization:

Applies scaling, outlier removal, and encoding (e.g., categorical to one-hot).
Generates standardized feature vectors.

### Callout 204—Biometric & Emotional Fusion:

Merges physiological signals and emotion estimates into the profile vector using weighted fusion.
Accounts for uncertainty by assigning confidence intervals.

### Callout 205—Attribute Vector Assembly:

Concatenates demographic, behavioral, biometric, and emotional features into a single vector.
Annotates each element with metadata tags (timestamp, source ID).

### Callout 206—Secure Storage/Federated Aggregation:

Optionally encrypts and stores the profile vector in a local or cloud database.
Supports federated learning by transmitting only model updates, not raw data.

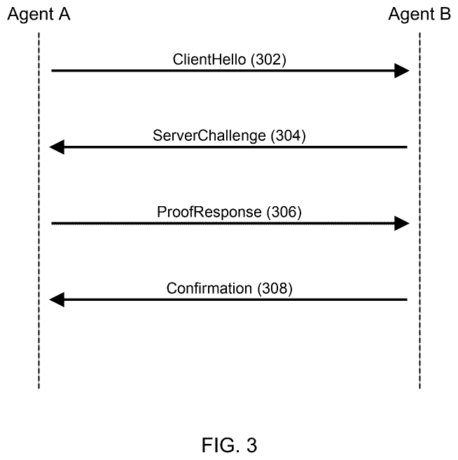

### FIG. 3—Agent-to-Agent Negotiation Sequence Diagram

With reference to FIG. 3, the sequence diagram shows a secure handshake and match metric exchange:

### ClientHello (302):

Agent A sends a ClientHello message including a session nonce to Agent B under TLS 1.3.

### ServerChallenge (304):

Agent B responds with a ServerChallenge containing its own nonce and a request for ZKP proof of attributes.

### ProofResponse (306):

Agent A generates a Zero-Knowledge Proof for specified profile attributes (e.g., age, interests) and sends it to Agent B.

### Confirmation (308):

Agent B verifies the ZKP and returns a Confirmation message with encrypted match metrics (e.g., compatibility score).

All communication is encrypted end-to-end and authenticated to prevent replay or tampering.

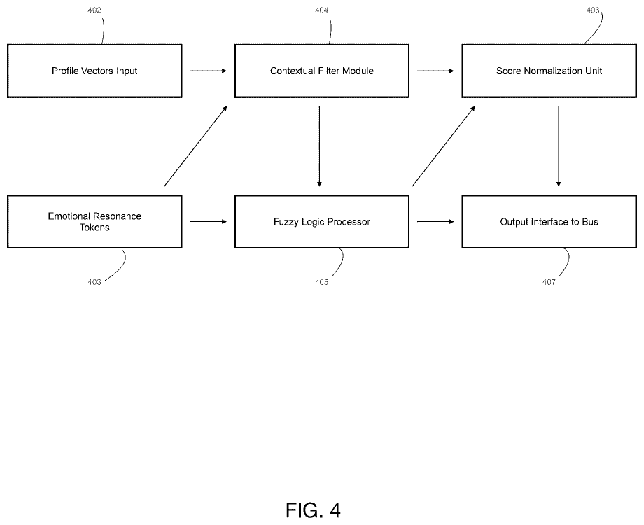

### FIG. 4—Compatibility Confidence Engine Block Diagram

With reference to FIG. 4, the block diagram shows internal modules of the Compatibility Confidence Engine:
Callout 402—Profile Vectors Input: Receives normalized deep profile vectors from the bus.
Callout 403—Emotional Resonance Tokens: Accepts optional resonance tokens derived from biometric/emotional inputs.
Callout 404—Contextual Filter Module: Applies user-defined filters (privacy depth, location, criteria).
Callout 405—Fuzzy Logic Processor: Performs fuzzy inference combining multiple features.
Callout 406—Score Normalization Unit: Converts raw inference output into a standardized 0-100% confidence score.
Callout 407—Output Interface to Bus: Emits the normalized score back onto the internal bus.

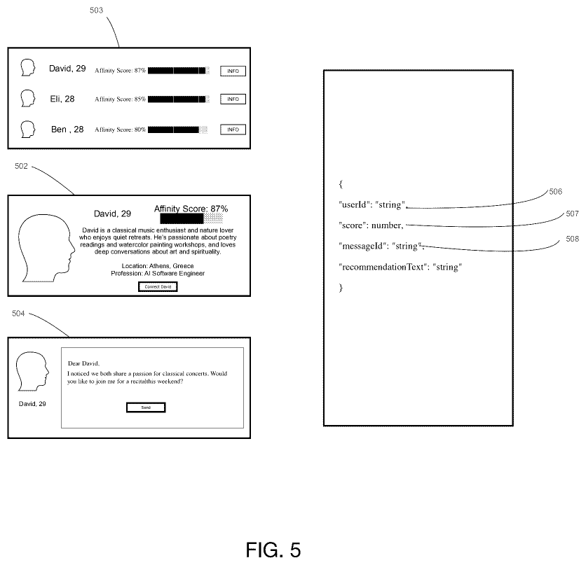

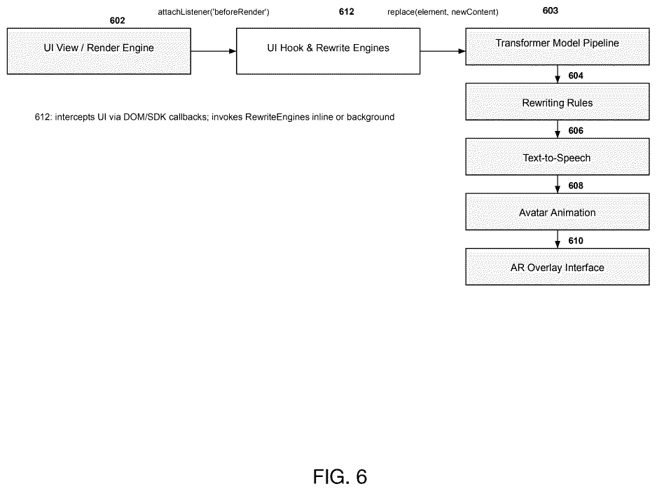

### FIG. 5—Match Recommendation Output UI and API Schema

With reference to FIG. 5:

FIG. 5 is a composite diagram showing both the user-interface flow and the backend API schema for match recommendations.
UI Mockups (Callouts 503-504) appear in the left column as three vertically stacked screens:
   List View (Callout 503): a scrollable list of candidate matches, each row showing a circular profile photo, the user's name and age (e.g., “David, 29”), an inline affinity bar (“Affinity Score: 87% [symbol] ”) and a small [info] button.
   Recommendation Card (Callout 502): upon tapping [info], this screen presents a medium-sized card with a larger profile photo, the name/age header, the same affinity bar, a brief text summary of shared interests, and a prominent [Connect]×button.
   Message Composer (Callout 504): after tapping [connect], this screen displays the recipient's profile photo and “David, 29” header, pre-populates the editable message field with an AI-drafted introduction—from the perspective of Sarah writing to David—for example, “Hi David, I noticed we both love quiet retreats and classical music. Would you like to meet for a concert this weekend?”—allows Sarah to edit or accept the message, and provides a bottom-centered [send] button.
API Schema (Callouts 506-508) is shown in the right column as a bordered JSON block titled “RESTful API Schema,” defining the /api/v1/recommendation response:

| | |
|---|---|
| { | |
| “userId”: “string”, | // Callout 506 |
| “score”: number, | // Callout 507 |
| “messageId”: “string”, | // Callout 508 |
| “recommendationText”: “string” | |
| } | |

This figure illustrates the end-to-end flow—from listing potential matches, through detailed profile and AI-driven invitation screens, to the backend API payload—thereby linking the frontend UX to the backend contract.

### FIG. 6—Rewriting & Presentation Engine Diagram

is a block diagram illustrating the data flow and integration points of the Profile Rewrite Module within the user interface. Callouts identify each processing stage:
602—UI View/Render Engine: The active front-end component that renders the user's profile view.
612—UI Hook & Rewrite Engines: An in-line interception layer that attaches a listener (attachListener(‘beforeRender’)) or SDK callback to capture the profile UI before rendering and invoke the rewrite engines synchronously (or in background when UI is inactive).
603—Transformer Model Pipeline: A GPT-style sequence-to-sequence neural network pipeline that rewrites textual content of the profile.
604—Rewriting Rules: A rule-based engine applying domain-specific style templates and personalization constraints to the rewritten text.
606—Text-to-Speech: A neural TTS component that generates synthesized audio greetings or prompts inline.
608—Avatar Animation Renderer: A GAN-based module that lip-syncs an animated avatar to synthesized speech or applies visual animations. 610—AR Overlay Interface: An optional augmented-reality overlay that displays rewritten content as immersive UI elements.

Arrows indicate the invocation sequence—first intercepting the UI render, then passing the profile content through the transformer, rewriting rules, and multimodal renderers—culminating in the final AR overlay. The legend (“612: intercepts UI via DOM/SDK callbacks; invokes RewriteEngines inline or background”) denotes the key UI hook functionality.

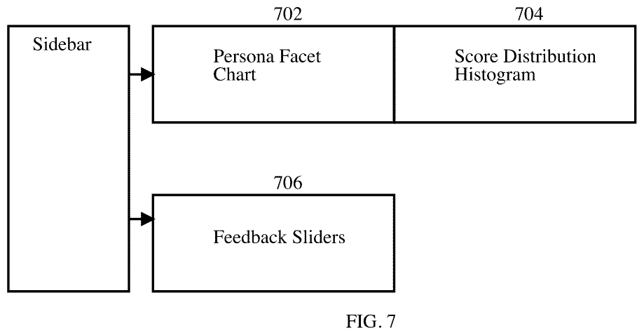

### FIG. 7—Compatibility Analytics Dashboard

With reference to FIG. 7, the Compatibility Analytics Dashboard provides both summary and control interfaces for end-users and system administrators:

### Sidebar Navigation Panel:

Located along the left edge of the dashboard (callout omitted), this panel enables users to switch between different analytics views (e.g., Persona Facet, Score Distribution, Feedback Controls).
Presents menu items such as “Overview,” “Personas,” “Match Scores,” and “Settings.”

### Callout 702—Persona Facet Chart:

A multivariate chart (e.g., radar or bar chart) displaying the user's key personality dimensions or profile facets—such as Openness, Conscientiousness, Extraversion, Agreeableness, and Neuroticism.
Each axis represents a distinct personality trait with normalized scores, allowing visualization of the user's profile fingerprint.

### Callout 704—Score Distribution Histogram:

A histogram showing the distribution of match scores across a selected pool of potential matches.
The x-axis represents score intervals (e.g., 0-20%, 20-40%, . . . 80-100%), and the y-axis shows the number of candidates in each interval.
Allows users to quickly gauge the overall quality of suggestions and identify outlier matches.

### Callout 706—Interactive Feedback Sliders:

Located below the Persona Facet Chart, a set of sliders enables real-time adjustment of contextual filter weights—such as “Location Proximity,” “Age Range,” “Interest Similarity,” and “Emotional Resonance.”
As sliders are moved, the dashboard dynamically updates the Persona Facet Chart and Score Distribution Histogram to reflect the new filter configuration.

All elements are connected by internal data flows (not shown) from the Compatibility Confidence Engine and data warehouse. This figure demonstrates how AI Matchmaker surfaces analytical insights and empowers users to refine matchmaking parameters for optimal recommendations.

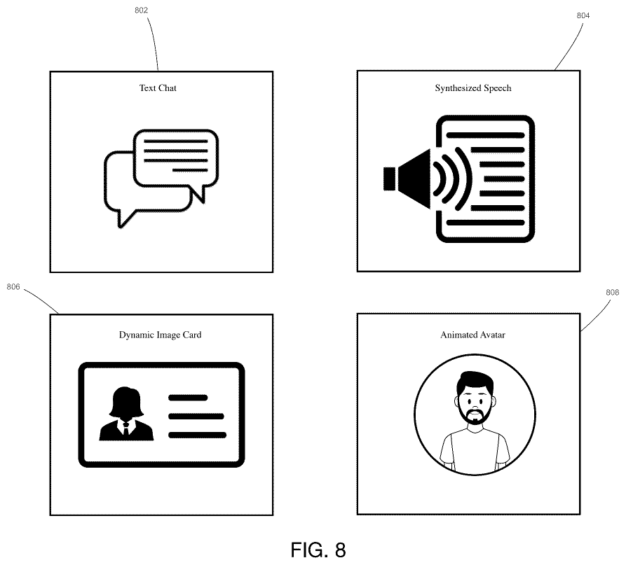

### FIG. 8—Presentation Modality Examples

With reference to FIG. 8, each quadrant demonstrates an example of how the AI Matchmaker delivers recommendations across different user-facing modalities:

### Callout 802—Text Chat Example:

Displays a conversational text message in a chat interface.
Presents the match recommendation as a chat bubble: “Hey Sarah, I found someone named David nearby who shares your love of classical music. Want to connect?”
Styled with user and system message distinctions, timestamps, and send/receive indicators.

### Callout 804—Synthesized Speech Example:

Shows a playback control panel (play, pause buttons) with a waveform or speaker icon.
Upon activation, the system reads the recommendation in a natural-sounding voice: “Hey Sarah, I found someone named David who shares your love of classical music. Would you like me to connect you?”
Supports volume control and language selection.

### Callout 806—Dynamic Image Card Example:

Renders a graphical card containing the match's photo, name/age (“David, 29”), and a visual affinity meter (e.g., a circular progress bar at 87%).
Includes a brief tagline of shared interests (e.g., “Classical music & quiet retreats”).
Card is tappable/clickable to expand to the Detail Page.

### Callout 808—Animated Avatar Interaction:

Displays a stylized avatar character with lip-sync and gesture animations.
The avatar delivers the match suggestion in a friend-like tone, with text captions appearing below: “I found someone special for you—David, 29. Interested?”
Supports real-time facial expressions (smile, nod) synchronized with speech.

Each presentation modality may be selected by user preference or device capabilities, providing a flexible, multimodal user experience for match recommendations.

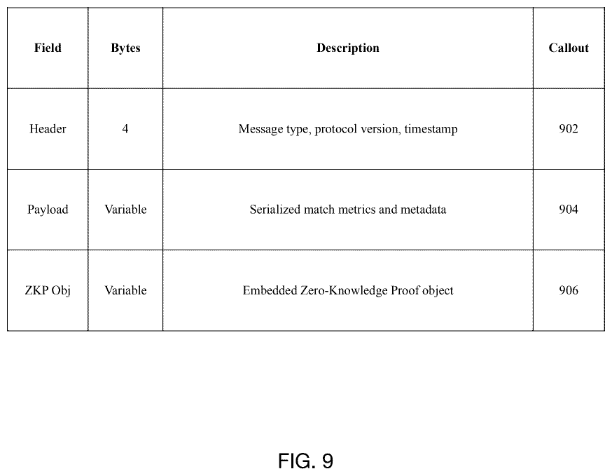

### FIG. 9—Packet Format Diagram

With reference to FIG. 9, each row corresponds to a logical field in the encrypted communication packet used by the Agent-to-Agent Negotiation Protocol:

### Header (902):

Size: fixed 4 bytes.
Contains message type identifier (e.g., Hello, Challenge, ProofResponse), protocol version, and a timestamp for replay protection.
Ensures both agents can parse and route messages correctly and prevent out-of-order or replayed packets.

### Payload (904):

Size: variable.
Carries serialized match metrics and metadata such as attribute similarity scores, confidence intervals, and optional contextual tokens.
Serialized using a compact binary format (e.g., Protocol Buffers or CBOR) to minimize bandwidth while preserving type safety.

### ZKP Obj (906):

Size: variable.
Contains an embedded Zero-Knowledge Proof object that cryptographically attests to certain properties of the user's deep profile without revealing raw data.
Formatted according to a standard ZKP scheme (e.g., zk-SNARK or Bulletproofs), allowing Agent B to verify proof correctness before accepting metrics.

### Data Flow:

During a TLS 1.3 handshake (as shown in FIG. 3), agents negotiate encryption keys.
Subsequent messages embed these fields in sequence: Header→Payload→ZKP Obj.
Upon receipt, the agent parses the Header (Field 902), decrypts and deserializes the Payload (Field 904), and verifies the ZKP Obj (Field 906) before passing match metrics to the Compatibility Confidence Engine.

FIG. 9 provides a clear specification of the inter-agent packet structure, ensuring consistency, security, and privacy in the communication protocol.

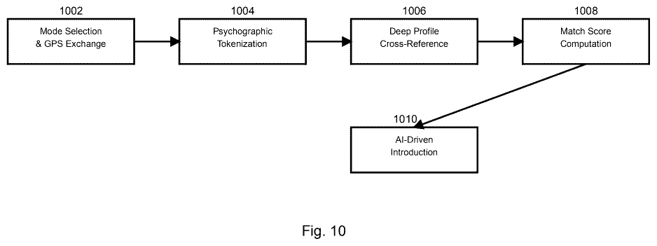

### FIG. 10—Nearby Flirt Matchmaking Mode Sequence and Block Diagram

In a user scenario for location-based flirting, FIG. 10 illustrates how the system handles a travel-mode match. With reference to FIG. 10, the “Nearby Flirt” matchmaking flow comprises:

### Callout 1002—Mode Selection & GPS Exchange:

Dana's AI Matchmaker activates “Nearby Flirt” mode based on user preference and current GPS location (Athens, Greece).
Agent A (Dana) and Agent B (Eli) exchange encrypted location data under a 5 km radius filter over TLS 1.3.

### Callout 1004—Psychographic Tokenization:

Each AI Matchmaker generates personality tokens by analyzing user questionnaire responses and social media “likes” (e.g., OCEAN personality dimensions, humor style).
Psychographic tokens are forwarded to the internal data bus for compatibility fusion under the Contextual Filter Module.

### Callout 1006—Deep Profile Cross-Reference:

Agents exchange only the opted-in deep profile fields (e.g., food preferences, travel history, hobbies, sexual orientation or dating preferences) over the secure channel.
Performs intersection analysis using fuzzy-logic within the Compatibility Confidence Engine.

### Callout 1008—Match Score Computation:

Combines location proximity, psychographic tokens, and profile intersections to compute a normalized match score (e.g., 0.87).

### Callout 1010—AI-Driven Introduction Suggestion:

The initiating agent formats a conversational prompt using the Rewriting & Presentation Engine—
“Hey Dana, I found someone named Eli here in Athens who shares your interests and is nearby. Would you like me to connect you?”—in a friend-like tone and presents this suggestion in the UI for user approval (e.g., via Message Composer, Callout 504).

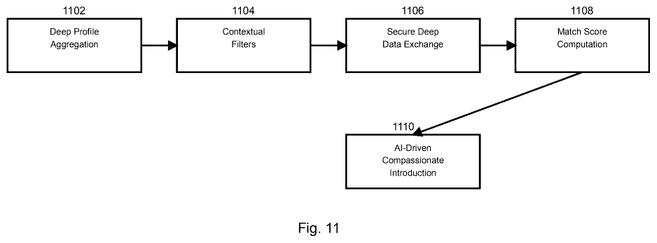

### FIG. 11—Widowed Soulmate Matching Scenario Sequence and Block Diagram

With reference to FIG. 11, the widowed soulmate flow comprises:

### Callout 1102—Deep Profile Aggregation:

Sarah's AI Matchmaker aggregates multi-source data, including long-term preferences (literature, travel destinations), family status (widowed), emotional triggers related to loss, and personal values into a unified deep profile vector.
Similarly, David's AI Matchmaker constructs a deep profile reflecting his widowhood status, resilience indicators, and affinity traits.

### Callout 1104—Contextual Filters:

The system applies user-defined filters for family status (widowed), age range compatibility, and preference for long-term relationship orientation.
Filters are enforced within the Compatibility Confidence Engine before data exchange.

### Callout 1106—Secure Deep Data Exchange:

Agents perform a peer-to-peer TLS 1.3 handshake and exchange selected deep attributes (e.g., literary tastes, travel experiences, coping styles, family backgrounds) as encrypted metrics.
Zero-Knowledge Proof objects ensure raw personal data remains private.

### Callout 1108—Match Score Computation:

The Compatibility Confidence Engine combines deep profile vectors, exchanged metrics, and contextual filter results to compute a normalized soulmate compatibility score (e.g., 0.92).

### Callout 1110—AI-Driven Compassionate Introduction Suggestion:

The initiating agent uses the Rewriting & Presentation Engine to craft a sensitive introduction—“Sarah, I found David who shares your love for quiet retreats and classical music, and understands the journey of loss. Would you like me to introduce you?”
Presents the suggestion in a compassionate tone for user approval via the Message Composer (Callout 504), using one or more presentation modalities selected from the group consisting of visual text, synthesized speech, animated avatar, or other available formats.

FIG. 11 demonstrates how the AI Matchmaker system supports deeply contextualized soulmate matchmaking for users coping with grief, ensuring privacy and empathy throughout the process.

### DETAILED DESCRIPTION

### Example Use Case: Soulmate & Flirt Matching Scenario:

In one embodiment, a user—Dana—engages with her AI Matchmaker in travel mode. Dana's Matchmaker knows she's in Athens, Greece, and that she's interested in flirting. The Matchmaker activates “Nearby Flirt” mode to find another user—Eli—also seeking a flirt in the same location.
Profile Construction: Dana's deep profile includes her preferences (jazz music, mountain biking, witty banter). Eli's profile emphasizes similar interests and a shared travel mindset.
Location-Based Matching: The Matchmakers exchange current GPS data and apply a location proximity filter (e.g., 5 km radius) to limit candidate pool to those nearby.
Emotional Resonance Exchange (Optional): Both agents gather real-time biometric signals (e.g., heart rate variability) during a brief virtual check-in to generate resonance tokens, if and only if each party's AI Matchmaker has the capability and the users have opted in to share such data.
Agent-to-Agent Deep Data Exchange: AI Matchmakers exchange and cross-reference selected deep profile data—such as food preferences, favorite restaurants, music tastes, intimate and sexual preferences, travel history, current residence, family status, fitness routines, and hobbies—only for the fields each user has opted to share. They then algorithmically compute compatibility intersections without user prompts. The broader and more comprehensive the shared data set each user opts to provide, the higher the potential accuracy and depth of the compatibility match.
AI-Driven Match Introduction: Once a matchScore above a threshold is determined, the initiating AI Matchmaker generates a personalized introduction message to propose the match to its user.
Match Scoring and Recommendation Delivery: Agents perform a TLS 1.3 handshake and ZKP exchange of tokens, then combine deep profiles, optional resonance tokens, and context filters (location, time) to compute a final matchScore of 0.87. Based on this score, the initiating AI Matchmaker communicates its findings to the user in a conversational, friend-like tone—e.g., “Hey Dana, I found someone named Eli here in Athens who shares your interests and is nearby. You have so much in common, and I think you'd be a great match. Would you like me to connect you?”

### Example Use Case: Widowed Soulmate Matching Scenario:

In one embodiment, a user—Sarah—has been widowed and is ready to re-enter the dating pool. Sarah's AI Matchmaker aggregates her deep profile including long-term preferences (literature, travel destinations), family status, emotional triggers related to loss, and personal values. Another user—David—also widowed, has similar deep profile attributes and is seeking companionship after loss.
Profile Construction: Sarah's deep profile reflects preferences for quiet retreats, classical music, and meaningful conversation. David's profile emphasizes similar interests and emotional resilience indicators.
Contextual Filters: The Matchmakers apply filters for family status (widowed), age range, and openness to long-term relationships.
Deep Data Exchange: Agents cross-reference selected profile data—literary tastes, travel experiences, coping style, and family background—algorithmically computing compatibility intersections without user prompts.
AI-Driven Match Introduction: Once a matchScore above a threshold is determined, the AI Matchmaker suggests: “Sarah, I found David who shares your love for quiet retreats and classical music, and understands your journey. Shall I introduce you?”

### 1. Deep Personal Profile Layer (Data Aggregation)

The Deep Personal Profile Layer aggregates user data from multiple sources to build a holistic profile through normalization and feature concatenation (see FIG. 2). This module comprises:
Database Architecture: A relational database schema with tables for user attributes, engagement events, and inferred features. Indexing on user_id and times tamp fields ensures low-latency queries.
API Endpoints: RESTful and gRPC interfaces (e.g., /api/v1/profile/aggregate) accepting JSON or Protocol Buffers payloads. Each endpoint defines required parameters, authentication via OAuth 2.0, and response schemas documented in OpenAPI.

### ETL Logic (Pseudocode):

| | |
|---|---|
| def | aggregate_user_data(user_id): |
| | “““ |
| | Aggregate and normalize data from multiple sources, |
| | compute feature vectors, and store the unified profile. |
| | ””” |
| | # Pull data from various sources |
| | sources = [ |
| | get_app_logs(user_id), |
| | get_clickstreams(user_id), |
| | get_third_party_data(user_id) |
| | ] |
| | # Normalize and merge records into unified format |
| | records = normalize_and_concatenate(sources) |
| | # Compute feature vectors |
| | profile = compute_features(records) |
| | # Persist the profile |
| | store_profile(profile) |
| | return profile |

Behavioral Data Sources: Application usage logs, time-series engagement metrics, and clickstreams collected at millisecond granularity.
NLP Models: Transformer-based sentiment analysis (e.g., BERT, RoBERTa) applied to chat and message transcripts to extract emotional tone.
Psychological Archetype Extraction: Big Five personality scores inferred via AI models trained on questionnaire responses and behavioral proxies.
Intimate Preference Mining: Both explicit preferences (form inputs) and implicit signals (dwell time, scroll depth) combined into preference vectors.
Cross-User Clustering: Unsupervised algorithms (e.g., K-Means, DBSCAN) applied to anonymized cohorts to identify high-success match archetypes.

Refer to FIG. 2 for the data aggregation pipeline of the Deep Personal Profile Layer. This means for aggregating multi-source user data is implemented by the Deep Personal Profile Layer as described above, including its database schema, API endpoints, ETL logic, and data processing pipelines.

### 2. Optional Emotional Resonance Layer (see FIG. 4)

When biometric or emotional inputs are available, this layer generates dynamic resonance tokens to enhance compatibility scoring. If such inputs are unavailable or undesired, matchmaking proceeds using only the deep profile vectors and contextual filters, without resonance tokens.

Refer to FIG. 4 for the optional resonance workflow.

### 3. Compatibility Confidence Engine (see FIG. 4)

The Compatibility Confidence Engine computes the final match score by combining deep profile vectors, an optional resonance token, and user-defined contextual filters-including temporal context (time of day), location proximity, cultural preferences, and event-based signals.

### Feature Fusion Algorithm:

score=Σi=1Nwi·vi+α·rscore=\sum_{i=1}\hat{ }{N}w_i\cdot v_i+\alpha \cdot r
where:
viv_i are profile feature values,
wiw_i are learned weights,
rr is an optional resonance token,
α/alpha is a tunable scaling parameter.
   Data Structures: In-memory matrices and sparse vectors optimized for low-latency dot products.
   Contextual Filters: A rule engine applies user-defined filters to negotiation metrics prior to scoring.

### Implementation (Pseudocode):

def compute match score (profile vector, metrics vector, filters):

filtered=apply_filters(metrics_vector,filters)

raw score=dot(weights,profile_vector)+alpha*filtered·resonance return sigmoid(raw score)

Refer to FIG. 4 for the flowchart of the Compatibility Confidence computation stages. This means for applying contextual filters and computing match scores is implemented by the Compatibility Confidence Engine as described above, including its feature fusion algorithm, data structures, and rule engine.

### 4. Agent-to-Agent Negotiation Protocol (see FIG. 3 & FIG. 9)

This module defines the peer-to-peer message exchange protocol between AI Matchmaker agents, supporting metric transfer and cryptographic proof verification.

### Handshake Sequence (FIG. 3):

a. Client Hello: Proposing Agent→Accepting Agent: HELLO with OAuth 2.0 token and TLS 1.3 ClientHello.
b. Server Challenge: Accepting Agent→Proposing Agent: CHALLENGE nonce.
c. Proof Response: Proposing Agent→Accepting Agent: RESPONSE containing signed nonce, ZKP proof object, and protocol version.
Zero-Knowledge Proof (ZKP) Module: Implements zk-SNARKs (e.g., libsnark or Rust equivalents) allowing a Proposing Agent to prove correctness of computed resonance metrics without revealing raw profile data. Real-time proof generation is optimized for latency under 50 ms per proof.

### Packet Structure (FIG. 9):

Header: message type, agent ID, sequence number, timestamp, authentication signature.
Payload: serialized match metrics and ZKP proof objects.
Transport & Security: All traffic runs over TLS 1.3 using the HC-256 cipher suite; acknowledgments and sequence control ensure reliable, ordered delivery.

### Deep Data Exchange Modes:

Full Sharing Mode: Exchange comprehensive profile fields selected by users (preferences, interests, behavior data).
Limited Data Mode: Exchange minimal essential fields (location proximity, general interests) to preserve privacy.
Error Handling & Sequencing: Automatic retransmission of dropped packets, exponential back-off on timeouts, and session renegotiation on repeated failures.

Refer to FIG. 3 for the secure handshake sequence diagram and to FIG. 9 for the detailed packet format. This means for exchanging match metrics is implemented by the Agent-to-Agent Negotiation Protocol as described above, including its handshake sequence, ZKP module, packet structure, and transport security components.

### 5. Match Recommendation Output (See FIG. 5)

The Match Recommendation Output module receives the computed match score from the BUS and presents it to end users via multiple interfaces. This module comprises:

### Compatibility Scoring Engine Implementation:

The Compatibility Scoring Engine implements probabilistic fusion of demographic, behavioral, and emotional inputs using Bayesian inference (e.g., Gaussian mixture models) or fuzzy-logic rules. This uncertainty handling logic normalizes and weighs noisy emotional signals prior to any rewrite operation, ensuring robust score generation even with incomplete or imprecise data.

User Interface Mockups:** Web and mobile wireframes illustrating recommendation cards, list views, and detail pages showing user attributes, match score, and call-to-action buttons.

API Endpoint:** A RESTful endpoint (‘/api/v1/recommendation’) returning JSON with fields: ‘match_id’, ‘score’, ‘attributes’, and ‘presentation_style’.

Webhook Events:** Server-side hooks for push notifications and in-app events, e.g.: json

```
{
  “event”: “match_computed”,
  “user_id”: “1234”,
  “match_id”: “5678”,
  “score”: 0.95
}
```

Error Handling: Retry logic for failed deliveries, schema version negotiation, and back-off strategies.

Refer to FIG. 5 for the user interface mockups and API schema of the Match Recommendation Output module. This means for outputting match recommendations is implemented by the Match Recommendation Output module as described above, including its UI mockups, RESTful/api/v1/recommendation endpoint schema, and webhook definitions.

### 6. Profile Rewrite Module Implementation (see FIG. 6)

The Profile Rewrite Module may be implemented as one or more of the following components, in combination or alone, each operating synchronously within the active UI render cycle and intercepting original UI elements via DOM injection or native SDK callbacks before rendering:
1. Textual Rewrite Engine
A transformer-based neural language model (e.g., GPT-style encoder-decoder) fine-tuned on dating profile corpora, configured to rewrite user-provided text inline within the same render cycle.
The engine exposes an API hook into the user interface (UI), replacing DOM elements or HTML/CSS containers in real time without requiring export/import or manual copy-paste.
End-to-end latency is maintained below 150 ms for text and graphics by employing lightweight distilled models or on-edge inference.

### 2. Graphical Rewrite Engine

A rule-based graphics template engine that swaps or re-colors profile images and icons based on compatibility tags (e.g., “adventurous”, “family-oriented”), executed within the UI rendering pipeline.
Hooks into the rendering pipeline to update SVG layers or Canvas elements seamlessly in-line.

### 3. Audio Rewrite Engine

A neural text-to-speech (TTS) component (e.g., Tacotron2+WaveGlow) that synthesizes personalized voice greetings or prompts inline within the UI render cycle.
Inline integration via Web Audio API or mobile audio SDKs, ensuring playback latency under 300 ms.

### 4. Video/Avatar Rewrite Engine

A GAN-based avatar module that lip-syncs a short avatar clip to synthesized speech or inserts auto-edited 5-10 second video snippets directly into the profile UI.
Integrated via a WebGL or native GPU-accelerated pipeline, with total processing time under 500 ms.

UI Integration and Hooks All engines operate via UI hooks (e.g., JavaScript listeners, native SDK callbacks) that intercept and replace existing profile content synchronously in memory, without requiring user-initiated export, import, or manual copy-paste operations.

```
# RewriteEngine pseudocode
def inline_rewrite(ui_view, new_content):
  listener = ui_view.attach_listener(‘beforeRender’)
  listener.on_event(lambda element:
  element.replace_with(new_content))
  # ensures replacement happens in same render cycle
```

### Business Model and Monetization

### Embodiments of the Invention Support Multiple Monetization Strategies:

Platform Licensing: Providers of matchmaking platforms integrate the plugin under a paid license (upfront fee+royalty based on subscription or match transactions).
Premium AI Subscriptions: End-users pay for enhanced AI Matchmaker features (deep insights, prioritized matching, analytics).
White-Label SaaS Deployment: The inventor operates a standalone service under custom branding.
Revenue Sharing Agreements: Inventor receives a percentage of platform revenues.

### ADDITIONAL EMBODIMENTS AND ANTI-CIRCUMVENTION

### Embodiments May Include Alternative Configurations and Protections:

Use-Case Specific Embodiments: Professional Networking, Family & Friendship
Multi-Modal Data Fusion: Voice, facial, text, IoT
Adaptive Learning & Self-Tuning
Hardware Acceleration & Edge Deployment
Compliance & Privacy Engine: This engine incorporates a comprehensive Consent Management Module for recording, storing, and validating user consents with time-stamped audit logs; a Data Anonymization Layer employing techniques such as k-anonymity and differential privacy to safeguard Deep Personal Profile data and resonance tokens prior to third-party sharing; and an immutable Audit Trail that logs every data access, processing event, and sharing transaction, thereby ensuring demonstrable compliance with GDPR, CCPA, and other relevant data protection regulations.
Real-Time Contextual Adaptation
API Ecosystem & Third-Party Integrations
Security Hardening
Testing & Analytics Framework
Globalization & Localization
Social Graph & Network Analysis
Gamification & Reward Engine
Explainability & Transparency Layer
Energy & Resource Efficiency
Data Provenance & Versioning

1. A system for AI-driven matchmaking between individuals, the system comprising: a. a Deep Profile Module configured to generate, from demographic inputs, behavioral inputs, and emotional inputs, a rich user representation; b. a Compatibility Scoring Engine configured to compute, based on the Deep Profile outputs, a ranked list of candidate matches; and c. a Profile Rewrite Module configured to automatically rewrite textual, graphical, audio, and video/avatar portions of a user's profile based on the Compatibility Scoring outputs, wherein: i. when the user-interface is active, said rewrite is performed in-line within the active user-interface view; and ii. when the user-interface is not active, said rewrite is performed asynchronously within the same user session or in the background, d. a Match Suggestion Module configured to generate and present contextual conversational prompts to the user based on the Compatibility Scoring outputs and rewritten profile—e.g., “Hey [User Name], there's someone here who matches your interests—would you like me to draft an introductory message for you?”; all without requiring user export, import, or manual copy-paste operations.

2. The system of claim 1, wherein the Profile Rewrite Module comprises a Textual Rewrite Engine implemented as a transformer-based neural language model configured to replace text content inline via a UI hook.

3. The system of claim 1, wherein the Profile Rewrite Module further comprises a Graphical Rewrite Engine that updates SVG or Canvas elements in real time based on compatibility tags.

4. The system of claim 1, wherein the Profile Rewrite Module further comprises an Audio Rewrite Engine using a neural text-to-speech model to synthesize personalized audio greetings inline.

5. The system of claim 1, wherein the Profile Rewrite Module further comprises a Video or Avatar Rewrite Engine that lip-syncs synthesized speech to a user avatar or auto-edits profile video snippets in real time.

6. The system of claim 1, wherein the Profile Rewrite Module performs all content replacement with an end-to-end latency of less than 200 ms.

7. The system of claim 1, wherein the Profile Rewrite Module intercepts and replaces existing profile content inline via a DOM injection or native SDK callback before any rendering occurs, without requiring any user-initiated export, import, or manual copy-paste operations.

8. The system of claim 1, wherein each rewrite operation performed by the Profile Rewrite Module is synchronized with the user-interface render cycle and completes in less than 150 ms end-to-end for text and graphics, less than 300 ms for audio, and less than 500 ms for video/avatar.

9. The system of claim 1, wherein the Compatibility Scoring Engine implements uncertainty handling via Bayesian inference or fuzzy-logic algorithms to fuse demographic, behavioral, and emotional inputs into a single multi-modal representation prior to any rewrite operation.

10. The system of claim 1, wherein the Deep Profile Module fuses demographic, behavioral, and emotional inputs into a single multi-modal representation before any scoring or rewriting is performed.

11. The system of claim 1, wherein, when the user-interface is not active, the Profile Rewrite Module performs all content replacement asynchronously in batch mode within the same user session, without requiring any user-initiated export, import, or manual copy-paste operations.

12. The system of claim 1, wherein the profile attributes further include biometric inputs selected from heart-rate variability, galvanic skin response, or facial expression metrics.

13. The system of claim 1, wherein the aggregation means performs federated learning across distributed client devices in a privacy-preserving manner without centralizing raw personal data.

14. The system of claim 1, wherein the Match Suggestion Module, acting as a proactive AI personal agent for the user, continuously monitors exchanged affinity representations and, upon detection of a candidate match exceeding a configurable compatibility threshold, automatically generates and delivers real-time conversational prompts to the user-such as personalized introductory messages-without requiring any user-initiated request.

15. The system of claim 1, wherein affinity representations or rewritten content are exchanged over any communication channel or protocol, including but not limited to REST, gRPC, WebSockets, message queues, blockchain transactions, or offline batch transfer.
